(19) United States
(12) Patent Application Publication
(10) Pub. No.: US 2012/0209920 A1
(43) Pub. Date: Aug. 16, 2012

(54) SOCIAL INFLUENCERS DISCOVERY

(75) Inventors: Eugene (John) Neystadt, Kfar-Saba (IL); Ron Karidi, Herzeliya (IL); Yitzhak Tzahi Weisfeild, Hod Hasharon (IL); Moshe Tennenholtz, Haifu (IL); Kira Radinsky, Zichron Yaakov (IL); Roy Varshavsky, Even Yehuda (IL)

(73) Assignee: Microsoft Corporation, Redmond, WA (US)

(21) Appl. No.: 13/042,463

(22) Filed: Mar. 8, 2011

Related U.S. Application Data
(60) Provisional application No. 61/441,568, filed on Feb. 10, 2011.

(51) Int. Cl. G06F 17/30; G06F 15/16

(52) U.S. Cl. 709/205; 707/723; 707/E17.005

(57) ABSTRACT

Social influencers may be identified for specific usage contexts and for influencer type. Influencers may be categorized by mavens, connectors, salesmen, or other categories. Within each usage context, a unified data model may be used to collect data from multiple sources, including multiple social networks, as well as to collect data from different levels of influencers in each usage context. The relevance of various communication media as well as the frequency and quality of use of the media may be factors used to determine a person's effectiveness as a specific type of influencer within a usage context.

### CROSS REFERENCE TO RELATED APPLICATIONS

This application claims the benefit of and priority to U.S. Provisional Patent Application Ser. No. 61/441,568 entitled “Social Network Based Contextual Ranking”, filed 10 Feb. 2011 by John Neystadt, et al., the entire contents of which are hereby incorporated by reference for all they teach and contain.

### BACKGROUND

Some people have more influence than others. Some people are experts in their field or have connections to people who may be experts. These people may be useful for marketing various products and services to specific people or the general public.

### SUMMARY

Social influencers may be identified for specific usage contexts and for influencer type. Influencers may be categorized by mavens, connectors, salesmen, or other categories. Within each usage context, a unified data model may be used to collect data from multiple sources, including multiple social networks, as well as to collect data from different levels of influencers in each usage context. The relevance of various communication media as well as the frequency and quality of use of the media may be factors used to determine a person's effectiveness as a specific type of influencer within a usage context.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a network environment with an influencer discovery and rating system.

FIG. 2 is a flowchart of an embodiment showing a method for identifying and classifying influencers.

FIG. 3 is a flowchart of an embodiment showing a method for responding to request for influencers.

FIG. 4 is a flowchart of an embodiment showing a method for responding to requests for influencers on demand.

### DETAILED DESCRIPTION

A system may detect social influencers by analyzing people's online activities and classifying those activities for specific usage contexts. The social influencers may be classified into several different influencer types, and a database of influencers may be useful in marketing and other activities.

The system may monitor direct and implicit items from which a person's relative level and type of influence may be computed. Direct items may include the number and content of blog posts, comments, email messages, instant messages, or other items. Implicit items may be the quantity and quality of a person's relationships within their social networks.

The system may operate in two modes. In a first mode, a database of influencers may be created by crawling the World Wide Web, social networks, and other databases to identify and classify influencers. An application may send a request for a list of influencers, and the system may search the pre-existing database to return a sorted list of influencers for a specific category or other parameters. In a second mode, the system may perform a search of the World Wide Web, social networks, and other databases after receiving the request for influencers.

For the purposes of this specification and claims, the term “social network” or “online social network” may relate to any type of computerized mechanism through which persons may connect or communicate with each other. Some social networks may be applications that facilitate end-to-end communications between users in a formal social network. Other social networks may be less formal, and may consist of a user's email contact list, phone list, mailing list, or other database from which a user may initiate or receive communication.

In some cases, a social network may facilitate one-way relationships. In such a social network, a first user may establish a relationship with a second user without having the second user's permission or even making the second person aware of the relationship. A simple example may be an email contact list where a user may store contact information for another user. Another example may be a social network where a first user “follows” a second user to receive content from the second user. The second user may or may not be made aware of the relationship.

In some cases, a social network may facilitate two-way relationships. In such a social network, a first user may request a relationship with a second user and the second user may approve or acknowledge the relationship so that the two-way relationship may be established. In some social networks, each relationship within the social network may be a two-way relationship. Some social networks may support both one-way and two-way relationships.

For the purposes of this specification and claims, the term “person” or “user” may refer to both natural people and other entities that operate as a “person”. A non-natural person may be a corporation, organization, enterprise, team, or other group of people.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

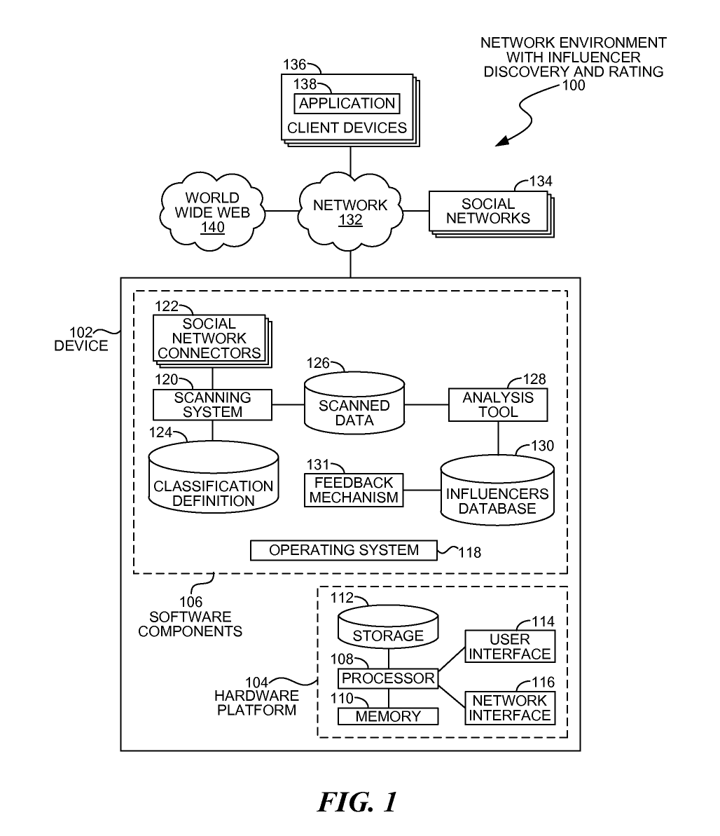

FIG. 1 is a diagram of an embodiment 100, showing an environment in which a system for ranking influencers may operate. Embodiment 100 is a simplified example of a network environment that may include a system that may search various social networks and other locations for people who may be influencers, then create and maintain a database of influencers. The system may provide information regarding influencers to various applications.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 is an example of a system that may maintain a database of influencers that are found in various social networks, the World Wide Web, various databases, or other online locations. Embodiment 100 may operate in two modes. In one mode, the database of influencers may be created prior to receiving a query for influencers and in a second mode, the database of influencers may be determined after the query is received.

The system may identify people who have influence. Influence may be a combination of various factors that may reflect how effectively a person may communicate a message. Influence may be derived from many different factors, including expertise, reputation, and a history of actions.

Expertise may be inferred or demonstrated by having knowledge or activity in certain fields. Expertise may come in the form of credentials, education, publications, or other demonstrations of knowledge. Reputation may be inferred or demonstrated by how other people relate to a person. The combination of these factors may be considered influence.

A person's influence may be determined by analyzing the person's online persona and activities performed online. The online information may be from formal social networks, such as online social exchanges that may be public, private, or have a combination of public and private communications. The online information may also be from informal social networks, which may be weblogs, forums, email distribution lists, or other communications.

Influencers may be persons whose reputation and influence may be valued by the user. The influence may be based on the person's activities on the World Wide Web, various databases, as well as activities in various social networks. For example, a person who writes articles for weblogs or other publications, or a person who comments or participates in online discussions may be considered to have expertise in certain categories or contexts. Various metric may include the number of publications on the topic, the frequency of publication, the frequency of publication compared to other people in the same or different categories, or other metrics.

Other metrics may include the importance or influence of the person's publications. The metrics may include how many times the person's works are referenced, how many subscribers may receive the person's works, the number of page views for the person's works, feedback or comments regarding the person's works, or other types of metrics.

The person's publications may be publically available publications, such as weblog postings, comments, or participation in public forums. In some embodiments, the person's publications may be private or semi-private publications, such as email messages, instant messenger messages, message transmitted within the confines of a social network, or other such messages.

In some embodiments, a person may authorize or permit access for an evaluation system to determine the person's influence or reputation. In such embodiments, a person may sign up for an evaluation of the person's relative expertise in various categories, and the system may provide credentials, offers, or other items in exchange as an enticement for the analysis.

In systems that may access information that may be considered private to the person, the person may have to expressly authorize the system to access such information. Without such access, the system may be limited to analyzing publically available information to determine a person's reputation.

The system may assess the quality of a person's communications in order to establish a person's expertise or influence. Various measures of quality may include the length of an article or publication, the circulation of the venue in which an article may be published, the citations or quotations of the person in other works, or other measures.

A person may also have influence through their social network activities. A person who is actively involved in social networking may have more influence than people who are not involved.

Various metrics from a social network may imply a person's reputation or influence. The sheer number of relationships may be a factor, and some embodiments may analyze the type or nature of the relationships. Such embodiments may identify relationships between experts in a field as an indicator that the person may also be an expert. Such embodiments may, for example, analyze the frequency that two people interact as an indicator of the strength of the relationship. In some embodiments, two people may enjoy multiple relationships through multiple channels. In such embodiments, the duplicative nature of the relationships may indicate a strong relationship.

In some embodiments, a social network graph may be constructed for each person. The graph may include one-way and two-way relationships and for each relationship, a quality metric may be evaluated for the relationship.

The quality metric may be a quantitative or qualitative assessment of the relationship, which may take into account the frequency of communication, recentness of communication, and the topic of communication. In some embodiments and under some conditions, the time of day or time of week of a communication may be relevant.

Some embodiments may consider whether a communication is an active or passive type of communication. A long weblog post may be considered an active type of communication as compared to the user activating a simple like/dislike toggle. Such an embodiment may give more weight to active communications than passive ones.

In many embodiments, each person's influence may be different for different categories or topics. Thus, a person's influence may be more than a vector representing a different influence score for various categories or topics.

When evaluating a single communication, group of communications, or other activities, the relevance of the communication to a specific topic may be analyzed. In some embodiments, the same communication may have different relevance for different topics. The relevance criteria for certain topics may be different from other topics. In a field such as fashion or the entertainment world, the relevance of a particular weblog article may vanish in a matter of weeks or days. In a field such as science or engineering, a weblog article about a scientific principle may be relevant forever.

For many applications, the actual propagation of a person's content or opinion through a chain of people may be a strong indicator of a person's influence. An example may be a success rate or conversion rate of a person's offers to other people, such as when the person offered a discount coupon or recommended a website, game, or other item to people in their social network. The conversion rate may strongly correlate to the person's influence.

In some instances, a person's comments or publications may start or may be part of a larger conversation across multiple weblogs, chat rooms, social networks, instant messaging, or other methods of communication. In such a case, the person's comments may be tracked or analyzed to determine what influence, if any, the person's comments had in the overall conversation. A person who produces commentary on a topic early and frequently in a long conversation may be considered to have a higher reputation and influence that someone who comments later in the conversation.

Embodiment 100 is an example of a single system that may perform all of the operations of generating and maintaining an influencer database. Embodiment 100 is just one example of such a system. In embodiments that crawl the entire World Wide Web 140 and maintain large databases, the system may be deployed in a cloud-based architecture that may use many hundreds or thousands of server computers to perform the operations described for embodiment 100. In such embodiments, each component may be executed on a different processor or set of processors.

The device 102 may have a set of hardware components 104 and software components 106. The client device 102 may represent any type of device that may communicate with a live system 126.

The hardware components 104 may represent a typical architecture of a computing device, such as a desktop or server computer. In some embodiments, the client device 102 may be a personal computer, game console, network appliance, interactive kiosk, or other device. The client device 102 may also be a portable device, such as a laptop computer, netbook computer, personal digital assistant, mobile telephone, or other mobile device.

The hardware components 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware components 104 may also include one or more user interface devices 114 and network interfaces 116. The user interface devices 114 may include monitors, displays, keyboards, pointing devices, and any other type of user interface device. The network interfaces 116 may include hardwired and wireless interfaces through which the device 102 may communicate with other devices.

The software components 106 may include an operating system 118 on which various applications may execute.

A scanning system 120 may crawl various social networks 134, the World Wide Web 140, or other network locations to search for influencers. In some embodiments, the scanning system 120 may operate as a background process to find information that may indicate a person's influence and store the information in a scanned database 126.

The scanning system 120 may have various social network connectors 122 which may interface with different social network. The social network connectors 122 may facilitate communication with and searching of a social network. Each social network may have a different social network connector.

In some embodiments, the social network connectors 122 may include logic, algorithms, heuristics, or other code that may make some preliminary assessments of the data that may be uncovered.

In many embodiments, the scanned database 126 may include a standardized or unified data schema that may represent information collected by the scanning system 120. The unified data schema may have data fields that may not correspond directly with information that a specific social network connector 122 may be able to retrieve. In such a case, the social network connector 122 may process information retrieved from a social network 134 to create a parameter that conforms with the schema of the scanned database 126.

The scanning system 120 may use a classification definition 124 to classify different topics of expertise or influence. In some embodiments, a hierarchical classification structure may be used. Other embodiments may have some type of graphical relationship between topics.

The scanning system 120 may collect various metadata about the influencers. Examples may include age, location, language, gender, or other metadata.

Some social networks or other databases may have built-in reputation indexes. In some such networks, the reputation indexes may reflect other people's votes of confidence, number of interactions, or other metrics. Such information may be used to help determine an influence score for a person.

After scanning the data and populating the scanned database 126, an analysis tool 128 may analyze the scanned data to populate an influencers database 130.

The analysis tool 128 may determine an influencer type for each person within each category. In some embodiments, the influencer type may be defined as a maven. A maven may be a type of influencer who may be a relative expert in a topic and one which proselytizes or communicates. In many cases, a maven may be considered an information specialist who may accumulate knowledge and can share the knowledge with others. A maven may be knowledgeable in a specific field or group of fields, such as a maven of photography and digital imaging, but the same person may not be a maven in other fields, such as politics or religion.

A maven may be characterized by having at least some expertise in a field and one which actively communicates in the field through their social networks.

Another influencer type may be a connector. A connector may have a large social network and may have an ability to connect experts in a field with people who may be seeking knowledge in the field. A connector may have the ability to converse in several different fields, but may not have the same demonstrated expertise as a maven may have.

A connector may be characterized as having a large social network in which the connector actively participates. A connector's social network may be very diverse and the connector may be a person who converses amongst several people on various topics, especially where one person in the conversation may be a relative expert in the topic with respect to other people in the conversation.

A third type of influencer may be a salesman. A salesman may have powerful negotiation skills and may be able to persuade people of their point of view. A salesman may be identified as one who may be particularly successful at having their point of view followed in various contexts. A salesman may be identified by having a large following in social networks where the following has especially strong feedback or ties to the salesman.

Some embodiments may include other types of influencers, including trendsetters, evangelists, and late influencers. A trendsetter may be a person who acts as an early adopter, whereas an evangelist may influence a tread at its peak. A late influencer may tend to join the end of a trend. Still other embodiments may have different types of influencers.

In some embodiments, a feedback mechanism 131 may update people's influence information in the influence database 130. The feedback mechanism 131 may receive input from outside sources, such as social marketing management systems or other systems to increase or decrease a person's influence factors in certain topics.

The system may operate in a network environment. The network 132 may be any type of network where the device 102 may communicate with various social networks 134 and the World Wide Web 140.

In many cases, a client device 136 may execute various applications 138 that may request data from the influencers database 130. For example, an application 138 that may present search engine results for specific topics may query the influencers database 130 to determine a set of influential people on a certain topic. The search engine results may include a list of people and links to those people's web pages. In another example, a social marketing system may query the influencers database 130 to identify mavens in a particular field. Those mavens may be given a sample product to review and discuss with their social network as part of a social marketing campaign.

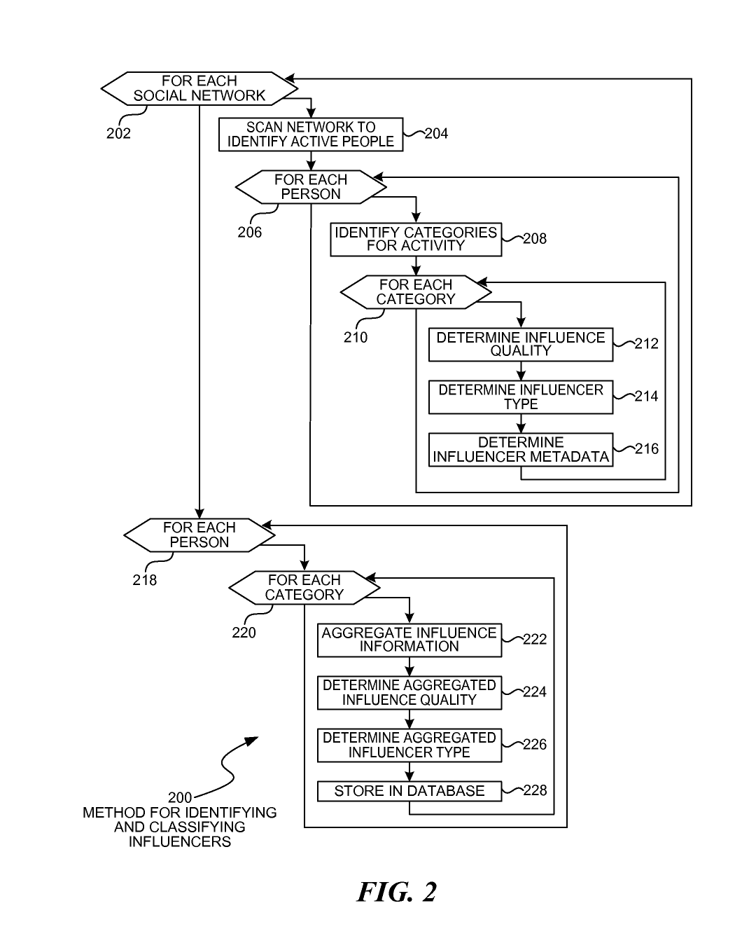

FIG. 2 is a flowchart illustration of an embodiment 200 showing a method for identifying and classifying influencers. Embodiment 200 is a simplified example of a method that may be performed to build up an influencers database prior to querying the influencers database. The operations of embodiment 200 may be performed by a scanning system and analysis tool, such as the scanning system 120 and analysis tool 128 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates a method by which influencers may be identified and classified. The influencers may be classified for different topics, and some people may be one type of influencer in one topic and another type of influencer in another topic.

In block 202, each social network may be analyzed. The social networks may be formal social networks, which may include those where people may broadcast short messages that other people may follow, or where people may post messages to be shared amongst other people who have an established relationship with the first person. Other formal social networks may be forums in which users may post articles in various threaded conversations, as well as distribution lists that use email, instant messaging, or other technologies to facilitate ongoing discussions on specific topics.

The social networks may also be informal social networks, such as the sphere of weblogs where people may post articles on a specific topic or variety of topics and for which various other people may comment or add their thoughts.

In some cases, the informal social networks may be people's contact lists, such as their phone, email, or postal mail lists. In many cases, such lists may be searched only when a user may have given permission for a system to access the lists.

For each social network in block 202, the network may be scanned in block 204 to identify active people. Each social network may have different thresholds for determining which people are active and which are not. The active people may be those people who participate in the conversations within the social network.

Each of the people may be analyzed in block 206. For each person in block 206, the categories relating to the person's activities may be identified in block 208. Each category may be analyzed in block 210. For each category in block 210, the influence quality for the person may be identified in block 212 and the influencer type may be identified in block 214. Any influencer metadata may be gathered in block 216. The operations of blocks 212 through 216 may be considered preprocessing the observed data from a specific social network.

Each embodiment may have different methods for analyzing activity. In some embodiments, a graph may be constructed showing unidirectional and bidirectional relationships. For each of the relationships, actual communications may be tracked and analyzed. The communications may be analyzed for recentness, frequency, time of day, or other factors. In some embodiments, the content of the communications may be able to be analyzed and categorized according to the category definitions. In some embodiments, an existing ranking system may be used as an influence metric.

In some embodiments, message propagation may be measured and used as an influence metric. The messages may be measured for impact on people's sentiment, referrals, quotations, links, or other mechanisms by which the impact of a person's message may be measured.

The influencer quality may be determined by the frequency, relevance, and content of an influencer's communications. Some categories may have different quality metrics than others. For example, a highly discussed topic may have a higher threshold for becoming an influencer than a topic that is not discussed often.

The influencer type may be characterized at least in part by the person's 0061 activities within a specific social network. For example, an influencer's maven-like communications may be determined from each social network analyzed.

After gathering and preprocessing observed data, the data may be aggregated and finalized. Each person may be analyzed in block 218. For each person in block 218, each relevant category for that person may be analyzed in block 220.

For each person and each category, the influence information may be aggregated in block 222 and an aggregated influence quality may be determined in block 224. The influence quality may be defined using qualitative or quantitative metrics. A qualitative metric may determine a general category, such as high, medium, low, for example. A quantitative metric may assign a number, such as a number between 0 and 1 or 1 and 10, for example.

An aggregated influencer type may be defined in block 226. In some embodiments, the influencer type may be determined by analyzing all of the person's activities over all of the social networks. In other embodiments, the influencer type may be aggregated by averaging or summing the influencer types determined in block 214.

The influencer information may be stored in an influencer database in block 228.

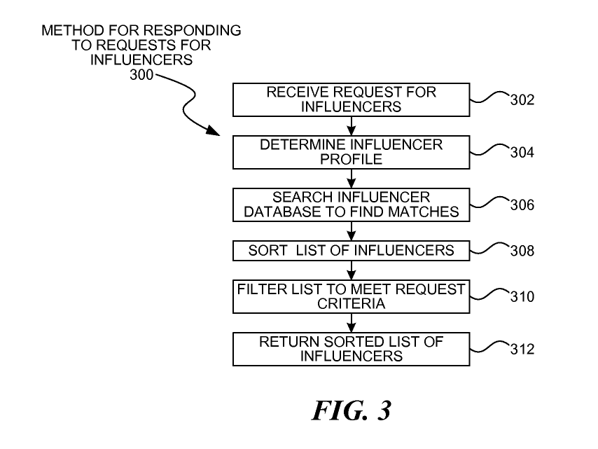

FIG. 3 is a flowchart illustration of an embodiment 300 showing a method for responding to requests for influencer information. Embodiment 300 is an example of a query that may be processed against an influencer database, such as the influencer database 130 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates an example of a process that may be performed when an application request a list of influencers. The request may be received in block 302. The request may define various criteria for the requested list, including category, the number of influencers, types of influencers, or other information. Each embodiment may permit different types of queries with various parameters.

The request may include a desired influencer profile in block 304. The desired influencer profile may define an influencer type within a specific category or topic. In some cases, the influencer profile may include age range, gender, educational background, location, and other factors.

The influencer database may be searched in block 306 to identify matching influencers. The results may be sorted in block 306 and filtered in block 308 to meet the request criteria. The sorted list may be returned to the application in block 312.

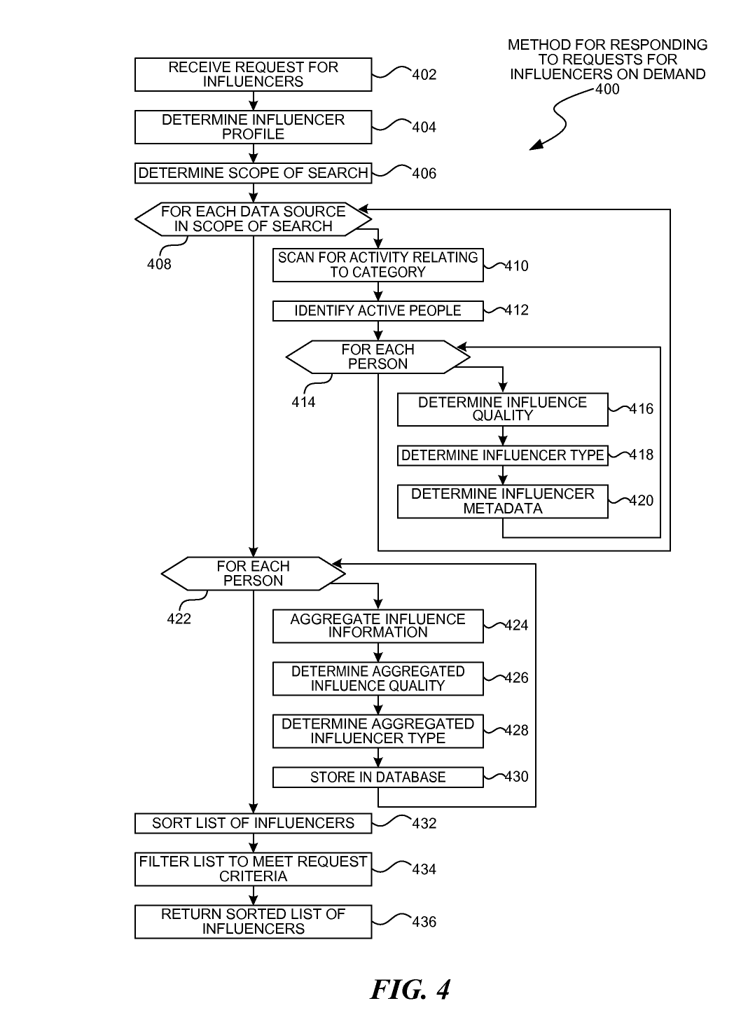

FIG. 4 is a flowchart illustration of an embodiment 400 showing a method for responding to requests for influencer information. Embodiment 400 differs from embodiments 200 and 300 in that embodiment 400 is an example of a query that may be processed on demand in that the search for an influencer may be performed after a request is received, whereas embodiment 200 may populate an influencer database prior to receiving a request for data in embodiment 300.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 illustrates a method for identifying influencers that may be performed after receiving a request. The method of embodiment 400 may search for a specific category and identify people who are active in the category. The people's actions may be analyzed to determine an influencer type and quality.

In block 402, a request may be received and an influencer profile may be determined in block 404. The request may be similar to that received in block 302 and the influencer profile may be similar to that determined in block 304.

The scope of a search may be determined block 406. In some embodiments, the scope of the search may be defined in the request. The scope of the search may define which social networks, document collections, or portions of the World Wide Web may be searched. The scope may be defined in terms of the specific data sources to search.

For each data source in block 408, the data source may be scanned in block 410 to identify any activity relating to the category. Based on the activity, the active people may be identified in block 412.

For each active person in block 414, the influence quality may be determined in block 416, the influence type may be determined in block 418, and any influencer metadata may be determined in block 420. The operations of block 416 through 420 may be similar to those of blocks 212 through 216 of embodiment 200.

Each person may be analyzed again in block 422. For each person in block 422, the influence information may be aggregated in block 424. An aggregated influence quality may be determined in block 426 and an aggregated influence type may be determined in block 428. The operations of blocks 424 through 428 may be similar to that of blocks 222 through 226 of embodiment 200.

The influencer information may be stored in the influencer database in block 430. In some embodiments, the influencer database may be used in subsequent requests for the same or similar information.

After identifying the influencers, the list of influencers may be sorted in block 432 and filtered in block 434 to meet the request criteria. The sorted list may be returned in block 436.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
identifying a plurality of categories;
for each of said categories in said plurality of categories:
retrieve documents from a plurality of communication media;
identify a plurality of persons having expertise in said categories;
for each of said persons, create an influencer profile and determine an expertise rating based on said documents; and
for each of said persons, determine an influencer type and an influencer type strength, and store said influencer type and said influencer type strength in said influencer profile.

2. The method of claim 1, said plurality of categories being defined in a hierarchical tree of categories.

3. The method of claim 2, said expertise rating being assigned to a node of said hierarchical tree.

4. The method of claim 1, said influencer type being one of a group composed of:
maven;
connector; and
salesman.

5. The method of claim 1, said influencer type being a maven identified by a plurality of material produced by said person relating to said usage context.

6. The method of claim 5, said influencer type strength being determined in part by analyzing social network connections for said person.

7. The method of claim 6, said influencer type strength being determined in part by analyzing social network connections for said person in a plurality of social networks.

8. The method of claim 7, said plurality of social networks comprising a first social network with one-way relationships and a second social network with two-way relationships.

9. The method of claim 1, said plurality of communication media comprising media having at least one two-way communication.

10. The method of claim 9, said communication media comprising instant messaging media.

11. The method of claim 1, said plurality of communication media comprising one-way communication.

12. The method of claim 11, said one-way communication being a weblog.

13. A system comprising:
a scanning system that scans an online document source to identify persons that have been active in a first topic;
an analysis tool that analyzes said persons to identify a plurality of persons that meet a set of influencer criteria, said set of influencer criteria being determined for each of a plurality of topics;
said analysis tool that, for each topic in said plurality of topics, determines a ranked list of influencers.

14. The system of claim 13, said document source comprising documents within a social network.

15. The system of claim 14, said document source comprising documents within a plurality of social networks.

16. The system of claim 15, said persons being categorized into a plurality of influencer types for each of said usage contexts.

17. The system of claim 16, one of said influencer types being a connector influencer.

18. A method performed on a computer processor, said method comprising:
identifying a plurality of categories, said categories being defined in a hierarchical tree of categories;
for each of said categories in said plurality of categories:
retrieve documents from a plurality of social networks;
identify a plurality of persons having expertise in said usage context;
for each of said persons, create an influencer profile and determine an expertise rating based on said documents; and
for each of said persons, determine an influencer type and an influencer type strength, and store said influencer type and said influencer type strength in said influencer profile.

19. The method of claim 18, at least one of said social networks comprising one-way relationships.

20. The method of claim 19, at least one of said social networks comprising two-way relationships.
